(19) United States
(12) Patent Application Publication
(10) Pub. No.: US 2026/0240324 A1
(43) Pub. Date: Aug. 20, 2026

(54) HAZARD MITIGATION CABINET

(71) Applicant: Bruce Neil WATKINS, Christchurch (NZ)

(72) Inventor: Bruce Neil WATKINS, Christchurch (NZ)

(21) Appl. No.: 19/164,770

(22) PCT Filed: Dec. 4, 2024
(86) PCT No.: PCT/NZ2024/050038

§ 371 Date: Sep. 12, 2025

(30) Foreign Application Priority Data
Apr. 13, 2023 (AU) 2023901080

(51) Int. Cl. A47B 81/00; A47B 96/02

(52) U.S. Cl. CPC A47B 81/00; A47B 96/02

(57) ABSTRACT

In one aspect the invention provides a hazard mitigation cabinet which defines a base, a roof, and at least one side wall or walls extending between the base and the roof. An access door is also located by at least one side wall or walls, with the side wall(s), door, base, and roof enclosing a secured volume and the door providing access to the secured volume. The cabinet also includes include at least one partition shelf extending between one or more side walls and the access door to divide the secured volume into two or more thermally isolated horizontal partitions.

### FIELD OF THE INVENTION

This invention relates to a hazard mitigation cabinet. In various embodiments the invention allows for the internal partitioning of this cabinet while also reducing heat transfers between adjacent partitions.

### BACKGROUND OF THE INVENTION

Dangerous goods cabinets have been developed to secure flammable, toxic or explosive materials, usually in work places or similar industrial settings. These cabinets are commonly provided with a robust sheet metal construction which seal and potentially lock these materials within a secured internal volume.

These cabinets can act to contain a fire fueled by flammable materials for a minimum period of time, allowing persons nearby to flee the area or undertake firefighting activities. In the case of explosive materials the robust construction of the cabinet can act to contain a blast and the pressure wave it generates, capturing and containing materials which would otherwise form shrapnel. Dangerous goods cabinets are usually required to meet government regulations aiming to protect the health and safety of a workforce which uses dangerous consumable materials.

These prior art cabinets have a simple internal structure, generally providing an interior volume for the storage of dangerous materials. Prior art cabinets can include simple sheet metal shelves to increase the carrying case capacity of the cabinet. This arrangement means that any combustion or explosion will engulf all materials stored in the cabinet.

Electrical devices and machines powered by rechargeable battery systems have experienced a significant growth in popularity in recent years. In particular Lithium Ion batteries are now commonly provided with cordless electrically powered tools.

These battery packs frequently need to be recharged over the lifespan of the related tool or appliance, with the charging process presenting some risks as the battery pack ages or experiences impact damage with normal wear and tear. The application of a charging current to a degraded battery pack can result in catastrophic failure of the containment of the individual cells of the battery. These failures can result in significant heat and noxious fumes being generated. Presently there is a low level of awareness of the risks posed by the charging of degraded battery packs-with most users simply finding a convenient power point to supply their recharging system.

Battery pack charging systems therefore present a new hazard to be addressed by users. The failure of a battery pack under charge does not generally result in combustion or explosive effects, but rather significant increases in the temperature of the battery. The large amounts of heat produced can potentially contribute to the failure of nearby batteries under charge, or combustion and/or explosion events for nearby flammable or explosive materials.

It would be of advantage to have improvements in the field of hazard mitigation cabinets which allowed for the internal partitioning of the cabinet while reducing heat transfers between adjacent partitions. In particular, improvements which allowed separate thermally isolated partitions to be deployed within a hazard mitigation cabinet would be of advantage. It would therefore be of advantage to have improvements in the field of hazard mitigation cabinets which could address any or all of the above problems, or at least provide the public with an alternative choice.

### DISCLOSURE OF THE INVENTION

According to one aspect of the present invention there is provided a hazard mitigation cabinet which defines a base, a roof, at least one side wall or walls extending between the base and the roof, and an access door located by at least one side wall or walls,
the at least one side wall, door, base, and roof enclosing a secured volume with the door providing access to the secured volume,
the cabinet including at least one partition shelf extending between one or more side walls and the access door to divide the secured volume into two or more thermally isolated horizontal partitions.

The invention provides a hazard mitigation cabinet used to secure and contained hazardous elements or materials. In various regions of the world these types of storage systems can also be referred to as dangerous goods cabinets. Such cabinets are used to manage the storage of materials which can present a health and safety risk for people working or present near to these materials. Commonly materials which are toxic, explosive, carcinogenic or highly flammable can be stored within such cabinets.

In preferred embodiments the hazard mitigation cabinet provided may also be used to contain materials, tools, or similar components which are capable of producing large amounts of heat, or which can present a risk of becoming an ignition source. For example, in various preferred embodiments the invention may be used to contain electrical batteries and their associated charging circuits or stations. As will be appreciated by those skilled in the art, the charging of damaged or degraded batteries can result in the battery failing and generating heat in the order of several hundred degrees Celsius. Although the failed battery does not necessarily combust or explode, it can form a combustion or detonation source for nearby explosive or flammable materials. Furthermore the heat generated by such failed batteries can also degrade other nearby batteries under charge, resulting in a cascade of heat related battery failures.

A hazard mitigation cabinet provided by the invention includes a base, roof and at least one side walls extending between the base and roof structures. An access door is also provided in association with the one or more side walls to enclose a secured internal volume defined by the cabinet. This internal volume can therefore be used to secure and store hazardous materials, with the door being used to access or deposit materials.

The volume secured by the cabinet can therefore be closed to contain stored hazardous materials, and also to prevent people nearby from being exposed to toxic, explosive or fire based hazards. In various embodiments the construction of the cabinet may give people nearby people the opportunity to flee a fire before it spreads from the cabinet or can contain shrapnel and pressure waves generated by the detonation of materials inside the cabinet.

In a preferred embodiment a hazard mitigation cabinet may include three side walls, forming the rear, left hand and right hand sides of the cabinet. The left and right hand side walls may also form a frame for the cabinet door which forms most of the front face of the cabinet. In such embodiments the cabinet may have a square or substantially rectangular shape.

Reference throughout this specification will also be made to the cabinet having three side walls and defining a square or cylindrical shape. However those skilled in the art will also appreciate that cabinets provided by the invention may include a single curve side wall to provide an overall cylindrical shape, or alternatively may define a triangular form with two angle side walls combined with a door. Reference to the provision of three side walls and rectangular form cabinets throughout this specification should in no way be seen as limiting.

In preferred embodiments the hazard mitigation cabinet may also incorporate at least one fan capable of moving air into or out of the secured volume of the cabinet. For example in various embodiments fans may be integrated into the side wall, walls, roof or base of the cabinet.

The operation a fan may be controlled manually in some instances. However in some preferred embodiments the cabinet may include a temperature sensor connected to a microprocessor configured to switch one or more fans on or off based on temperature sensor signals.

In various embodiments a fan or fans integrated into the cabinet can act to reduce interior temperatures while batteries are being charged or stored, and may also acts to reduce temperatures in the cabinet in the event of a battery failing and generating heat.

In various preferred forms of such embodiments a plurality of fans may be provided in the cabinet side wall(s) to service an array of horizontal partitions formed in the interior of the cabinet. In such embodiments a fan may be provided for each horizontal partition formed in the interior of the cabinet.

In some preferred embodiments the hazard mitigation cabinet may define at least one vent in a side wall. Vents can allow for the passive circulation of air through a cabinet, particularly when the interior of the cabinet is warmer than its surrounding environment.

In further preferred embodiments the side wall or walls of the cabinet may define a plurality of vents with a vent provided for each horizontal partition of the cabinet. In such embodiments localised heating experienced within a particular horizontal partition may be reduced through the circulation of cooler air delivered from the outside of the cabinet.

In various preferred embodiments the hazard mitigation cabinet may include a plurality of power supply outlets engaged with at least one of its side walls. In a further preferred embodiment at least one power supply outlet may be provided within each horizontal partition. The provision of power supply outlets allows the cabinet to be used to recharge batteries from a source of electrical energy connected to the power supply outlet or outlets.

The hazard mitigation cabinet provided includes at least one partition shelf which extends between the interior of the side walls of the cabinet and its door. A partition shelf will therefore divide the secured volume into two horizontal partitions. This partition shelf forms a barrier which acts to thermally isolate the two adjacent horizontal partitions. Materials stored or supported by the upper surface of the shelf in one partition can be shielded from heat or high temperatures present in the adjacent lower horizontal partition.

Those skilled in the art will appreciate that references made to the thermal isolation of horizontal partitions will appreciate that heat transfer is still possible but greatly attenuated between adjacent partitions. Partition shelves exposed to high temperatures for long enough time periods will inevitably allow for some heat transfer, while the various embodiments of the invention have a significant impact on how much heat is transferred and how quickly heat is transferred.

As indicated above the invention may find particular utility in the storage and charging of battery systems. High temperatures generated by the failure of a degraded battery under charge in one horizontal partition can be isolated from an adjacent partition.

Preferably a partition shelf may define a width, length or circumference which fits the perimeter of the shelf immediately adjacent to the side wall or walls of the cabinet. This arrangement of the partition shelf mitigates the potential for heat to transfer between adjacent horizontal partitions.

Reference throughout this specification will be made to the perimeter of a partition shelf being dimensioned so as to in contact with or be approximately 1 mm away from interior surfaces of the side walls and door. However those skilled in the art will appreciate that other distances or tolerances may be used in practice in other embodiments if required.

In a preferred embodiment the cabinet may include a plurality of shelves. This array of shelves can divine the entire secured volume into a stack of thermally isolated horizontal partitions.

Reference throughout this specification will be made to the cabinet including three shelves which form a stack of four thermally isolated partitions. However those skilled in the art will appreciate that the invention may only provide a single shelf or only two shelves in other embodiments.

In a preferred embodiment the partition shelves include at least one layer of thermal insulator material, where preferably the mass and the thickness of the thermal insulator impede the transmission of heat through the partition shelf. In a further preferred embodiment the thermal insulator may have a thickness, mass and/or composition which impedes the transmission of heat through the shelf.

In preferred embodiments the thermal insulator may be formed from a material which is not damaged by exposure to temperatures above 500 degrees Celsius. In further preferred the thermal insulator may be formed from a material which is not damaged by exposure to temperatures in the range of 500-1600 degrees Celsius.

In some preferred embodiment the thermal insulator may be formed from a ceramic material such as a block of ceramic board or ceramic blanket, and may be dimensioned with approximately the same width depth and height as the shelf to be formed. These ceramic-based thermal insulators can therefore act effectively to prevent heat transfer between adjacent horizontal compartments.

In other preferred embodiments the thermal insulator may be formed from a mineral material such as—for example—a mineral wool or fibre material. In further particular embodiments high temperature mineral fibre or wool materials may be used form of thermal insulator, with the materials selected preferably being resistant to temperatures above one thousand degrees Celsius. In various instances of such embodiments the mineral thermal insulator may be formed with approximately the same width depth and height dimensions as the partition shelf.

In a preferred embodiment a partition shelf may include at least one exterior skin layer. A skin layer may cover and at least partially enclose at least one side of the thermal insulator. Preferably an exterior skin may form an upper surface for the shelf, or an underside surface for the shelf, or may extend around both.

In a preferred embodiment an exterior skin layer may include a sheet of metal. Metal sheets provide robust forms of supporting surfaces for shelves and define a strong platform to support the weight of materials based upon them.

In a preferred embodiment a partition shelf may include two exterior skins, the first forming the upper surface of the shelf and the second forming the underside surface of the shelf. Those skilled in the art will however appreciate that in other embodiments the invention may incorporate a single exterior skin, preferably forming the upper surface of the shelf.

However in other embodiments different arrangements may be used, including the provision of a thermal insulator without any exterior skin layers, and/or a thermal insulator engaged with an exterior skin forming an underside surface for the shelf. Reference made to the provision of two exterior skins sandwiching a thermal insulator should therefore not be seen as limiting.

In a preferred embodiment one or more shelves may be provided with an exterior skin layer which defines one or more edge projections. Such projections may extend towards the opposite face or surface of the shelf to that covered by the skin layer, and in some embodiments may engage with these a further skin layer covering the opposite side of the shelf.

In preferred forms edge projections may extend outward approximately to the same distance as the thickness of the thermal insulator. In such embodiments each projection can therefore define an exterior edge surface for the shelf running perpendicular to its upper and lower surfaces. The provision of one or more edge projections also allows the thermal insulator to be fully enclosed by an exterior skin material.

In a further preferred embodiment an edge projection of a skin layer may have an L or C-shaped form, preferably by presenting an additional surface extending from the tip of the edge protection parallel to an adjacent surface of the thermal insulator. In such embodiments the edge projection may form both an edge surface and a strengthening rib which runs along the length or width of the shelf. C or L-shaped bracket profiles can abut the edges of the thermal insulator.

In some embodiments an exterior skin layer or any edge protection projection it defines may extend to engage a side wall of a cabinet. In various preferred embodiments complimentary shaped structures—such as a hook and receiving cavity—can be formed in either edge projections or side walls to securely connect a partition shelf to a side wall of the cabinet. For example in some embodiments an edge projection may define a hook received by a complimentary aperture formed in a side wall—or alternatively may define a receiving cavity for a complimentary hook formed on or by a side wall. Preferably the complimentary connection systems provided may prevent the shelf from being slid forwards towards the door of the cabinet as a relatively heavy load is removed from it's the surface.

The present invention may provide many potential advantages over the prior art.

The present invention can provide a hazard mitigation cabinet which defines a stack of thermally isolated horizontal partitions. The partition shelves used to achieve this can impede the transmission of heat from an adjacent cell to its neighbour, preventing an ignition source in one partition degrading, igniting or detonating the contents of another partition.

In various embodiments the partition shelf provided has a relatively lightweight form with high structural strength. In additional embodiments a partition shelf can be firmly fixed to and engaged with the side walls of the cabinet to prevent it being withdrawn from the cabinet accidentally.

In various preferred embodiments the form taken by edge covering projections can define strengthening beams which improve the weight carrying and strength characteristics of a partition shelf.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 shows a perspective view of a hazard mitigation cabinet as provided in accordance with a preferred embodiment,

FIG. 2 shows a perspective view of a portion of a partition shelf as provide in an alternative embodiment, and

FIG. 3 shows a perspective exploded view of parts of a partition shelf provided in accordance with another embodiment.

Further aspects of the invention will become apparent from the following description of the invention which is given by way of example only of particular embodiments.

### BEST MODES FOR CARRYING OUT THE INVENTION

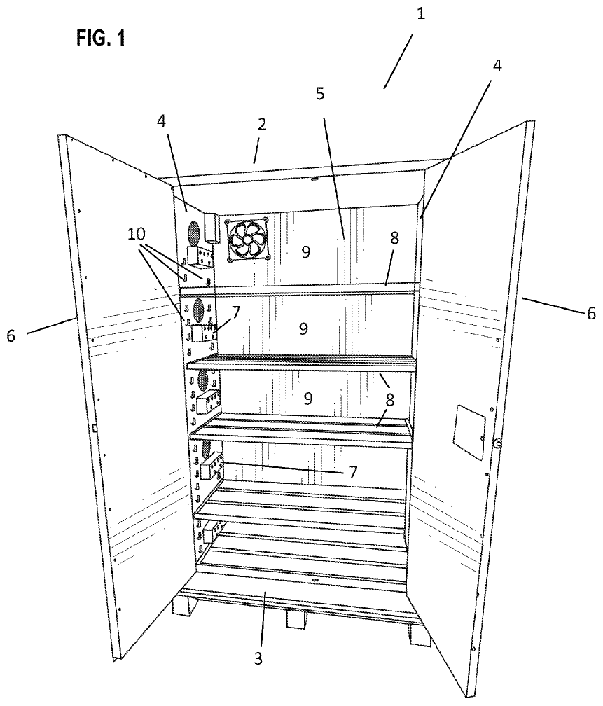

FIG. 1 shows a perspective view of a hazard mitigation cabinet as provided in accordance with a preferred embodiment. As can be seen from this figure the cabinet 1 includes a roof 2 base 3 left and right side walls 4 and a rear wall 5. The secured volume defined by the cabinet is fully enclosed when the two front doors 6 are pivoted to a closed position As can be seen from FIG. 1 the left interior side wall also provides a number of power supply ports 7.

In the embodiment shown the cabinet includes four partition shelves 8, dividing the secured volume into a stack of five thermally isolated horizontal partitions 9.

Projecting hooks 10 formed on the left and right side walls engage the shelves 8 at desired heights within the cabinet. An array of projecting hooks provide flexibility in where shelves can be located within the secured volume.

In the embodiment illustrated by FIG. 1 each of the shelves 8 may preferably be used to support the weight of battery systems and their charging circuits. These charging circuits can be supplied from one of the power supply ports 7 available adjacent to each shelf 8. The construction of each partition shelf, as discussed further below thermally isolates each horizontal partition from its neighbours, thereby preventing the failure of batteries under charge from causing an ignition, degradation or detonation effect in an adjacent partition.

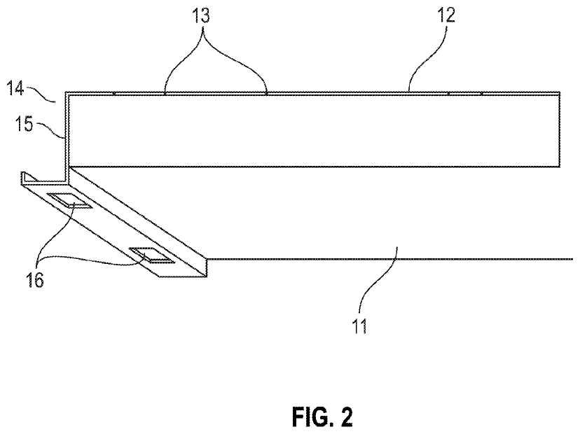

FIG. 2 shows a perspective view of a portion of a partition shelf as provide one embodiment. In the embodiment shown the partition shelf is formed from a layer of thermal insulator 11, provided in this embodiment by thermally insulating ceramic board. The upper surface 12 of the shelf is provided by a thin steel sheet pop riveted 13 into the upper surface of the thermal insulator 11.

The upper skin 12 defines an edge projection 14 extending perpendicular to the edge of the thermal insulator 11, defining an exterior edge surface 15 for the sheet. The same edge projection also defines a connection system 16 for the side walls of a hazard mitigation cabinet. The connection projection showing defines a pair of cavities which receive hooks formed on the side wall of the cabinet.

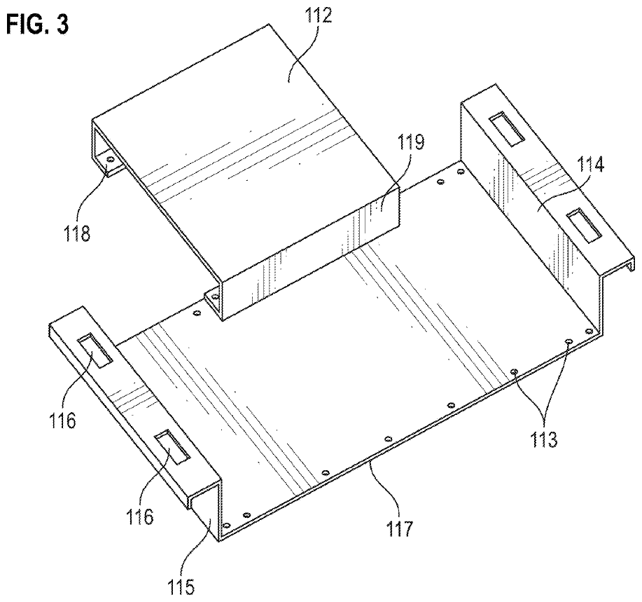

FIG. 3 shows a perspective exploded view of parts of a partition shelf provided in accordance with another embodiment. This embodiment differs from that shown by FIG. 2 by providing two separate exterior skin layers 112, 117. The upper surface skin 112 can be engaged with the lower surface skin 117 using pop rivets 113. Similarly with the embodiment shown in FIG. 2 the lowest skin can also defines projections 114 covering the edge of the shelf and connector systems 116 to engage with the side walls of the cabinet.

The upper skin 112 also defines a pair of edge projections 118 with each of these forming a C-shaped bracket running the length of the shelf edge. This type of edge projection substantially increases the overall structural integrity and strength of the shelf.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1. A dishwasher table which includes
a housing which defines an interior volume which locates a washing assembly,
a panel located within a frame mounted to the housing, at least one side of the panel defining a utensil surface, the panel incorporating an interior volume which defines a manifold in communication with a plurality of apertures formed in the utensil surface,
a pivot assembly which at least partially engages the panel with the housing and allows the panel to move to present the utensil surface to the interior of the housing or to face the utensil surface away from the interior of the housing,
a vacuum pump connected to the manifold defined by the interior volume of the panel, whereby operation of the vacuum pump engages dining utensils placed over one or more of the apertures formed in the utensil surface with the utensil surface.

2. The dishwasher table as claimed in claim 1, which includes a coverage sensor associated with each aperture formed in the utensil surface, each coverage sensor being adapted to provide an output signal which indicates if the aperture is covered by a dining utensil.

3. The dishwasher table as claimed in claim 2, which includes a valve assembly associated with each aperture formed in the utensil surface, each valve assembly being adapted to block access to the manifold when an associated coverage sensor indicates the aperture is not covered by a dining utensil.

4. The dishwasher table as claimed in claim 3, wherein the valve assembly includes a spring loaded piston movable to block or expose an entry port of the manifold, the piston being moved by an electrical solenoid, wherein activation of the electrical solenoid compresses the piston spring and exposes the manifold entry port.

5. The dishwasher table as claimed in claim 2, wherein a coverage sensor is formed by an optical sensor which detects the presence or absence of light and issues a signal.

6. The dishwasher table as claimed in claim 5, wherein the coverage of an aperture by a dining utensil blocks light reaching the sensor triggering the sensor to issue a signal indicating that the aperture is covered.

7. The dishwasher table as claimed in claim 2, wherein a coverage sensor actively emits infrared radiation, with the reflection of infrared radiation back to the sensor indicating that the associated utensil surface aperture has been covered by a dining utensil.

8. The dishwasher table as claimed in claim 3, which includes a microcontroller connected to the plurality of coverage sensors and valve assemblies, the microcontroller being configured to receive signals from coverage sensors and issue control signals to valve assemblies.

9. The dishwasher table as claimed in claim 8, wherein the microcontroller is programmed to open a valve assembly when an associated aperture has been covered by a dining utensil.

10. The dishwasher table as claimed in claim 1, wherein the panel is mounted within the frame using one or more seals deployed between the panel and frame.

11. The dishwasher table as claimed in claim 1, wherein the pivot assembly operates to present the utensil surface as the upper surface of the dishwasher table when the table is used by diners and to present the utensil surface engaged with dining utensils to the interior volume of the housing.

12. The dishwasher table as claimed in claim 1, wherein pivot assembly includes at least one axle located in substantially the middle of one side of the panel, said at least one axle being engaged with a bearing assembly allowing rotation of the panel relative to the frame and housing.

13. The dishwasher table as claimed in claim 12, which includes a pair of axles positioned opposite one another on opposed sides of the panel.

14. The dishwasher table as claimed in claim 12, wherein at least one axel is engaged with a drive motor used to apply a rotational force to the panel to pivot the panel relative to the table frame and housing.

15. The dishwasher table as claimed in claim 12, wherein the pivot assembly includes at least one lifting arm engaged between an axle of the pivot assembly and the table housing, the lifting arm or arms being configured to lift the panel above and out of the frame away from the housing prior to the panel being pivoted relative to the table housing.

16. The dishwasher table as claimed in claim 1, which includes a filter connected between the vacuum pump and manifold defined by the interior volume of the panel, the filter being arranged to separate solids and liquids from gases drawn through the manifold and to supply gas to the vacuum pump.

17. The dishwasher table as claimed in claim 16, wherein the filter includes a separation chamber divided by an internal baffle with an inlet port and outlet port located on either side of the baffle.

18. The dishwasher table as claimed in claim 16, wherein the separation chamber includes a drain to allow for the removal of the solids and liquids.

19. A method of operating the dishwasher table as claimed in claim 1, comprising the steps of:
i. operating the vacuum pump to engage dining utensils placed over one or more of the apertures formed in the utensil surface with the utensil surface,
ii. using the pivot assembly to move the panel and present the utensil surface to the interior of the housing,
iii. activating the washing assembly located within the interior volume of the housing to wash the dining utensils suspended from the utensil surface.

20. The method of operating a dishwasher table as claimed in claim 19, which includes the additional preliminary step of opening a valve associated with any aperture formed in the utensil surface when an associated coverage sensor indicates the aperture is covered by a dining utensil prior to operating the vacuum pump.
